(19) United States
(12) Patent Application Publication
(10) Pub. No.: US 2021/0201706 A1
(43) Pub. Date: Jul. 1, 2021

(54) LABEL STRIP

(71) Applicant: Silver Fox Limited, Hertfordshire (GB)

(72) Inventor: Nicholas David Michaelson, Hertfordshire (GB)

(21) Appl. No.: 16/755,321

(22) PCT Filed: Oct. 12, 2018
(86) PCT No.: PCT/GB2018/052924

§ 371 Date: Apr. 10, 2020

(30) Foreign Application Priority Data
Oct. 13, 2017 (GB) 1716820.4

(51) Int. Cl. G09F 3/04; G09F 3/00

(52) U.S. Cl. CPC G09F 3/04; G09F 2003/0201; G09F 3/0295

(57) ABSTRACT

A label strip is provided including a first band and a second band, a label which is optionally provided with a protrusion at each end of the length thereof, wherein each of the first and second bands is provided with a cut out, wherein the first and second bands are located parallel to each other with a gap therebetween, wherein when the label is located between the first and second bands it fits into the gap created between the cut outs of the bands; and
wherein a layer of adhesive material is provided on one side of the first and second bands extending over the cut outs such that the label when positioned in the cut outs is held in position by the adhesive material.

### FIELD OF THE INVENTION

This application relates generally to labelling devices. More particularly, the application relates to labelling devices used with electronic printing devices.

### BACKGROUND OF THE INVENTION

In devices or equipment, such as in airplanes, boats, marine oil and gas processing industries, rail, power and clean power, computer networks or equipment that contains many wires, cables, or other items that may either get easily tangled or confused with other similar items, it is necessary to label the wires, cables or groups of cables of wires. Tags and marker assemblies have been designed to form labels for such uses. Heat shrink technology has been employed in making these markers and tags thereby permitting easy installation. Once applied, the labels are difficult to remove.

Generally, a carrier strip of material containing a plurality of markers is fed through a machine, whereby the markers will pass through a printing station for imprinting images onto each marker.

U.S. Pat. No. 8,357,442 describes one alternative of a wire marker. A carrier strip is provided which includes a first layer having at least one opening, two bands applied to opposite edges of the first layer, the bands including an adhesive on at least one side, and a label secured into the opening and attached to the adhesive. At least one access perforation may be located on the first layer that is horizontal and adjacent to one side of the opening. The access perforation facilitates removal of the label from the carrier and allows for insertion of a cable through the label. A plurality of horizontal carrier perforations may further be located between each opening on the first layer to facilitate removal of the carrier strip from a printer. The problem with this alternative is that there is a considerable amount of wastage of material in the carrier strip described.

U.S. Pat. No. 4,865,895 describes a marker sleeve assembly comprising a series of flattened tubular recoverable marker sleeves held by at least one longitudinal carrier strip which holds the sleeves in fixed spaced apart relationship extending laterally from the strip. In particular it describes a marker sleeve assembly which comprises a pair of parallel longitudinal carrier strips the inner edges of which have two layers with adhesive means on the inside facing surfaces of the two layers. The ends of the flattened tubular recoverable marker sleeves are positioned between the layers and held in position by the adhesive means on the inside surfaces of said layers of the carrier strips. The flattened marker sleeves are spaced apart whereby a portion of each adhesive means on the inside surface on each said layer of each carrier strip alternately engages the ends of the flattened marker sleeves and the opposing adhesive means on the opposing surface of the opposing layer of that carrier strip. The opposing adhesive means engaging each other aid in holding the flattened tubular marker sleeves in their flattened configuration in the assembly. The problem with this alternative is that there is a substantial bulk of material at each end of the labels where there are two layers of carrier strips, the label plus 2 layers of adhesive. This bulk of material may get clogged as it passes through printing machines.

In a further alternative a single layer of carrier strip can be provided at each end can be provided upon which there is a first layer of adhesive, then the label. The problem with this alternative is that if only a single layer of adhesive is used then there is a risk of contamination of the labels themselves, as the adhesive between the labels is exposed and open to attract dust, and also contamination of the print heads of the printer as it possible for the exposed adhesive to transfer onto the print heads. This problem could be solved by provided two layers of adhesive strip, however, they would need to be carefully aligned so that the two layers of adhesive met and covered each other. In addition there would be a gap between the layers of adhesive between the labels, into which dirt and grime and other contaminants could be trapped, and therefore a stamping process would be needed, which would need to be carefully aligned to push the adhesive layers together so that they are stuck together between the labels. This is all laboursome, overcomplicated and therefore expensive, and prone to errors.

### SUMMARY OF THE INVENTION

According to a first aspect of the invention there is provided a label strip comprising:
a first band and a second band, wherein the first band has a width and a thickness and the second band has a width and a thickness, and wherein the thicknesses of the first and second bands are substantially the same;
a label, wherein the label has a width, a length and a thickness;
wherein each of the first and second bands is provided with a cut out at least substantially the same width as the width of the label and having a depth of less than the width of each of the first and second bands;
wherein the first and second bands are located parallel to each other with a gap there between;
wherein the gap between the bands, plus the depths of each of the cut outs, is at least substantially the same as the length of the label, such that when the label is located between the first and second bands, it fits into the gap created between the cuts outs of the bands; and
wherein a layer of adhesive material is provided on one side of the first and second bands extending over the cut outs such that the label when position in the cut outs is held in positon by the adhesive material.

This is advantageous as the adhesive material is fully covered either by the first and second bands or the labels located in the cut outs where the adhesive would have been exposed so there is a reduced risk of contamination. Furthermore, the tensile strength and elasticity of the adhesive strip is not as significant as one does not have the problem ensuring that the adhesive strip is exactly aligned.

In one alternative each of the first and second bands is provided with a cut out the width of which is slightly larger than the width as the width of the label.

In one alternative each of the first and second bands is provided with a cut out the width of which is substantially the same width as the width of the label.

In one alternative the gap between the bands, plus the depths of each of the cut outs, is slightly larger than the length of the label

In one alternative the gap between the bands, plus the depths of each of the cut outs, is substantially the same as the length of the label.

In an alternative there is provided a label strip comprising:
a first band and a second band, wherein the first band has a width and a thickness and the second band has a width and a thickness, and wherein the thicknesses of the first and second bands are substantially the same;
a label, wherein the label has a width, a length and a thickness, the label is provided with a protrusion at one end of the length thereof;
wherein each of the first and second bands is provided with a cut out one of which is at least substantially the same width as the width of the protrusion, one of which is at least substantially the same width as the label and each having a depth of less than the width of each of the first and second bands;
wherein the first and second bands are located parallel to each other with a gap there between;
wherein the gap between the bands, plus the depths of each of the cut outs, is at least substantially the same as the length of the label plus protrusion, such that when the label is located between the first and second bands, it fits into the gap created between the cuts outs of the bands; and
wherein a layer of adhesive material is provided on one side of the first and second bands extending over the cut outs such that the label when position in the cut outs is held in positon by the adhesive material.

In one alternative wherein each of the first and second bands is provided with a cut out one of which the width of which is slightly larger than the width of the protrusion, one of which the width of which is slightly larger than the width as the label.

In one alternative wherein each of the first and second bands is provided with a cut out one of which the width is substantially the same as the width of the protrusion, one of which the width of which is substantially the same as the width as the label.

In one alternative the gap between the bands, plus the depths of each of the cut outs, is slightly larger than the length of the label plus protrusion.

In one alternative the gap between the bands, plus the depths of each of the cut outs, is substantially the same as the length of the label plus protrusion.

In a further alternative there is provided a label strip comprising:
a first band and a second band, wherein the first band has a width and a thickness and the second band has a width and a thickness, and wherein the thicknesses of the first and second bands are substantially the same;
a label, wherein the label has a width, a length and a thickness, the label is provided with a protrusion at each end of the length thereof;
wherein each of the first and second bands is provided with a cut out at least substantially the same width as the width of the protrusion and having a depth of less than the width of each of the first and second bands;
wherein the first and second bands are located parallel to each other with a gap there between;
wherein the gap between the bands, plus the depths of each of the cut outs, is at least substantially the same as the length of the label plus protrusions, such that when the label is located between the first and second bands, it fits into the gap created between the cuts outs of the bands; and
wherein a layer of adhesive material is provided on one side of the first and second bands extending over the cut outs such that the label when position in the cut outs is held in positon by the adhesive material.

In one alternative wherein each of the first and second bands is provided with a cut out the width of which is slightly larger than the width of the protrusion.

In one alternative wherein each of the first and second bands is provided with a cut out the width is substantially the same as the width of the protrusion.

In one alternative the gap between the bands, plus the depths of each of the cut outs, is slightly larger than the length of the label plus protrusions.

In one alternative the gap between the bands, plus the depths of each of the cut outs, is substantially the same as the length of the label plus protrusions.

Preferably label in the label strip is configured to be printed on. Wherein a single layer of adhesive material is provided on only the underside of each of the first and second bands, this has the additional advantage that the full label can be printed on and none of the label is masked from printing by the adhesive strip.

Optionally the first and/or second bands are also configured to be printed on. The printing on the first and/or second bands can include information on how to install the labels, where to install the labels or other information. In one alternative the printing on the first and/or second bands takes place directly on to the bands themselves, in another alternative a layer of a print receiving material is provided on the first and/or second bands to onto which the printing takes place, or in the further alternative the printing may take place onto the adhesive strip and in this alternative the adhesive strip is configured to be receptive for such printing.

In one alternative the label is substantially the same thickness as the thickness of the first and second bands, in another alternative the thickness of the label is greater than the thickness of the first and second bands. Ideally the thickness of the label should not be less than the thickness of the first and second bands otherwise the label printer may have problems printing on the label.

This is advantageous as the label fits snugly into the bands, the bands being the same thickness as the material so that the labels do not get caught as they are not sticking up, and there is less wastage of any carrier material lending to a more environmentally friendly product.

In one alternative the widths of the first and second bands are substantially the same, in an alternative one of the bands is wider than the other band, such that the first band is wider than the second band or the second band is wider than the first band.

Optionally a second layer of adhesive material is provided on the other side of the first and second bands extending over the cut outs such that the label when position in the cut outs is held in positon by the adhesive material both on the top and on the bottom.

In one alternative the first and second bands are provided with apertures or sprocket holes for use with a continuous feed style printer.

Preferably when label is provided with a protrusion, the protrusion is substantially the same shape as the cut out.

Optionally the label is provided with more than one protrusion and the first and second bands are provided with more than one cut out per label of the same shape as the protrusions. It is worth noting that the protrusions if provided on either side of the label do not themselves need to be the same as each other, so for example on one side of the label there might be only one protrusion with a matching cut out in the first band and on the other side of the label there might be two protrusions with matching cut outs in the second band. The protrusion on one side of the label could be a circular tab like one finds on a traditional jigsaw puzzle with a matching cut out in the first band and on the other side of the label the protrusion is instead a square tab with a matching cut out in the second band. In a further alternative the protrusion on each side may be the same shape, but different sizes. In yet a further alternative multiple protrusions may provided on one or both sides of the label which may be of different numbers on each side if provided on both sides. It may also be that a protrusion is provided only on one side of the label.

Optionally each of the edges of the label are provided with a perforation so that the label, once printed, can be removed from the first and second bands simply by tearing the label along the perforations, rather than having to pull the label away from the adhesive material.

Preferably the label is a heat shrink label.

### BRIEF DESCRIPTION OF THE DRAWINGS

Other aspects and features of the present invention will become apparent to those ordinarily skilled in the art upon review of the following description of specific embodiments of the invention in conjunction with the accompanying figures.

FIG. 1 illustrates a top view of a label strip according to an embodiment of the present invention;

FIG. 2 illustrates a top view of a label strip according to an embodiment of the present invention;

FIG. 3 illustrates a top view of a label strip according to an embodiment of the present invention;

FIG. 4 illustrates a side cross-sectional view of a label strip according to an embodiment of the present invention;

FIG. 5 illustrates a side cross-sectional view of a label strip according to an embodiment of the present invention; and

FIG. 6 illustrates a side cross-sectional view of a label strip according to an embodiment of the present invention.

### DETAILED DESCRIPTION OF PREFERRED EMBODIMENTS

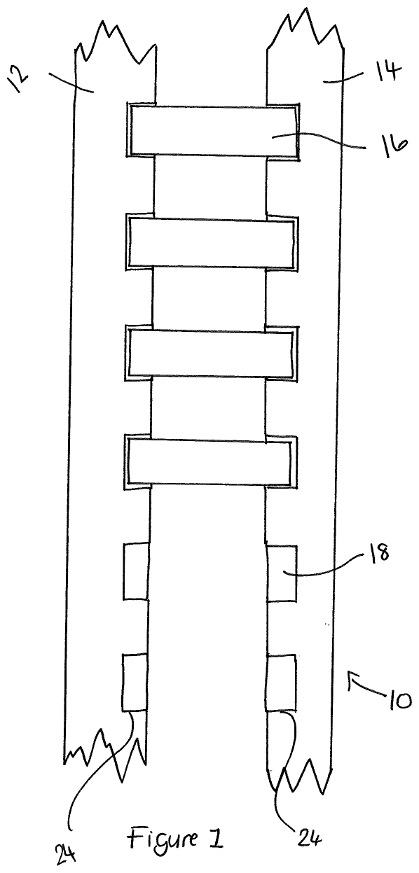

FIG. 1 illustrates a top view of a label strip 10 according to an embodiment of the present invention comprising a first band 12 and a second band 14 and a label 16. The first band 12 has a width and a thickness and the second band 14 has a width and a thickness. The thicknesses of the first and second bands 12, 14 is substantially the same. The label 16 has a width, a length and a thickness. The label 16 is in one alternative the same depth as the thickness of the first and second bands 12, 14, and in another alternative of a greater depth.

Each of the first and second bands is provided with a cut out 24 substantially the same width as the width of the label 16 and a depth of less than the width of each of the first and second bands 12, 14.

The first and second bands 12, 14 are located parallel to each other with a gap in between them

The gap between the bands 12, 14 plus the depths of each of the cut outs 24 is substantially the same as the length of the label 16 such that when the label 16 is located between the first and second bands 12, 14 it fits into the gap created between the cut outs 24 of the bands 12, 14.

A layer of adhesive material 18 is provided on one side of the first and second bands 12, 14 extending over the cut outs 24 such that the label 16 when position in the cut outs 24 is held in positon by the adhesive material 18. The adhesive material 18 may be provided either on the top of or the bottom of the first and second bands 12, 14.

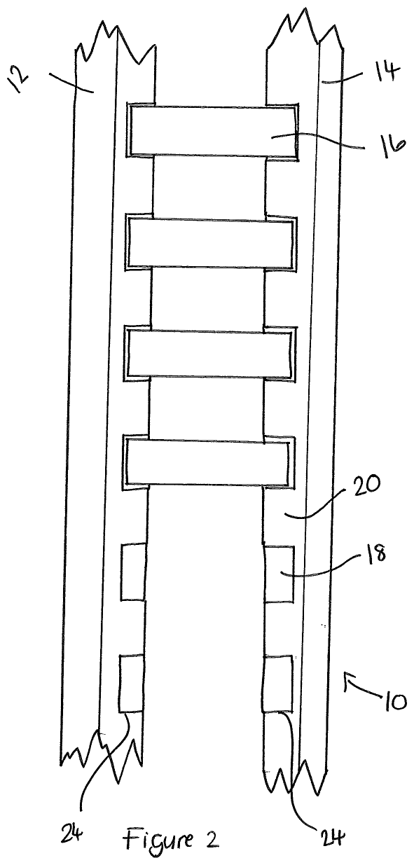

FIG. 2 illustrates a top view of the label strip shown in FIG. 2 wherein an additional layer of adhesive material 20 is provided on the other side of the first and second bands 12, 14 extending over the cut outs 24 such that the label 16 when position in the cut outs 24 is held further in positon by the additional layer adhesive material 20.

FIG. 7 illustrates a further alternative where perforations 224 are provided in the label 216 such that the label 216 can be removed from the label strip leaving the portion of the label held in position by the adhesive material 18 in situ.

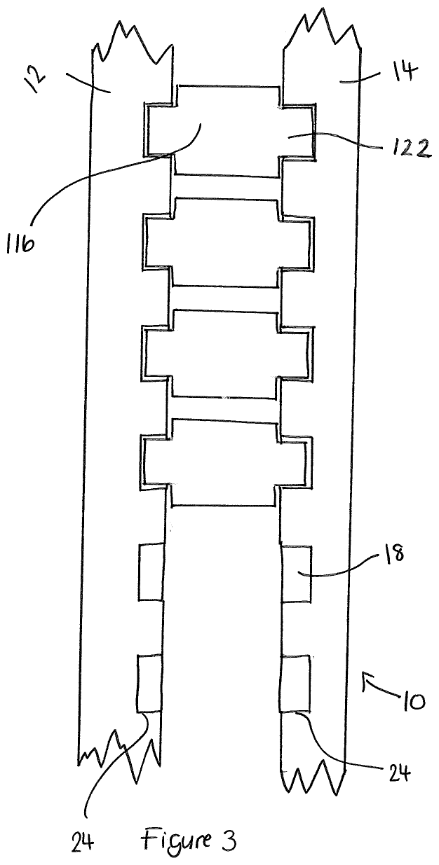

FIG. 3 illustrates a top view of a label strip 10 according to an embodiment of the present invention comprising a first band 12 and a second band 14 and a label 116. The first band 12 has a width and a thickness and the second band 14 has a width and a thickness. The thicknesses of the first and second bands 12, 14 is substantially the same. The label 116 has a width, a length and a thickness. The label 116 is provided with a protrusion 122 at each end of the length thereof. The label 116 is in one alternative the same depth as the thickness of the first and second bands 12, 14 and in another alternative of a greater depth.

In the embodiment illustrated a single protrusion is provided, however, in the alternative a plurality of protrusions may be provided each with a respective cut out in each of the first and second bands. In one alternative the cut out is a mirror image of the protrusion. Further in the alternative the protrusions can be any size or shape with mirror image cut outs provided in each of the first and second bands. As discussed above the protrusions, if provided, on either side of the label do not themselves need to be mirror images of each other, so for example on one side of the label there might be only one protrusion with a matching cut out in the first band and on the other side of the label there might be two protrusions with matching cut outs in the second band. The protrusion on one side of the label could be a circular tab like one finds on a traditional jigsaw puzzle with a matching cut out in the first band and on the other side of the label the protrusion is instead a square tab with a matching cut out in the second band. It may also be that a protrusion is provided only on one side of the label.

Each of the first and second bands is provided with a cut out 24 substantially the same width as the width of the protrusion 122 of the label 116 and a depth of less than the width of each of the first and second bands 12, 14.

The first and second bands 12, 14 are located parallel to each other with a gap in between them

The gap between the bands 12, 14 plus the depths of each of the cut outs 24 is substantially the same as the length of the label 116 plus protrusions 122 such that when the label 116 is located between the first and second bands 12, 14 it fits into the gap created between the cut outs 24 of the bands 12, 14.

A layer of adhesive material 18 is provided on one side of the first and second bands 12, 14 extending over the cut outs 24 such that the label 116 when position in the cut outs 24 is held in positon by the adhesive material 18.

An additional layer of adhesive material (not shown) may be provided on the other side of the first and second bands 12, 14 extending over the cut outs 24 such that the label 16 when position in the cut outs 24 is held further in positon by the additional layer adhesive material.

FIG. 8 illustrates a further alternative where perforations 324 are provided in the label 316 such that the label 316 can be removed from the label strip leaving the protrusions 322 in situ.

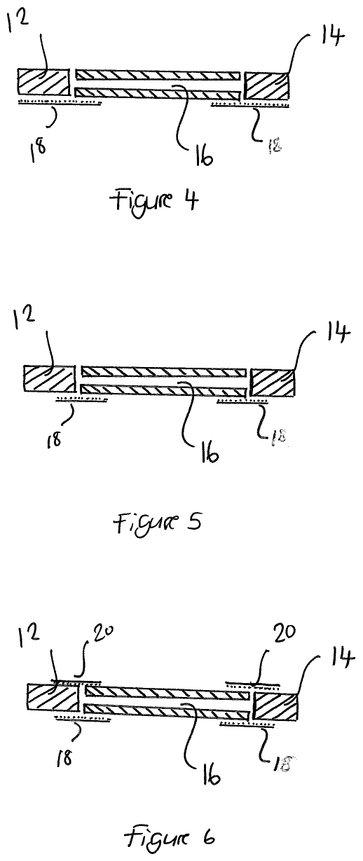

FIG. 4 illustrates a side cross-sectional view of a label strip according to an embodiment of the present invention wherein a single strip of adhesive material 18 is provided which extends the full width of each of the bands 12, 14.

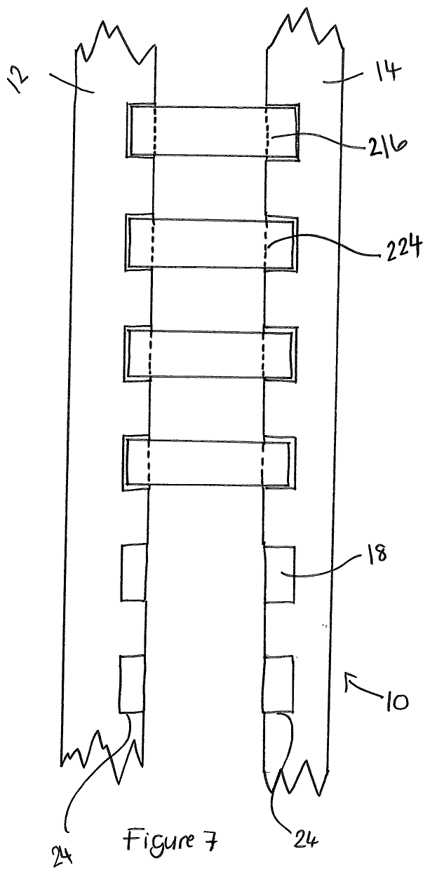

FIG. 5 illustrates a side cross-sectional view of a label strip according to an embodiment of the present invention wherein a single strip of adhesive material 18 is provided which only extends across of portion of the width of each of the bands 12, 14.

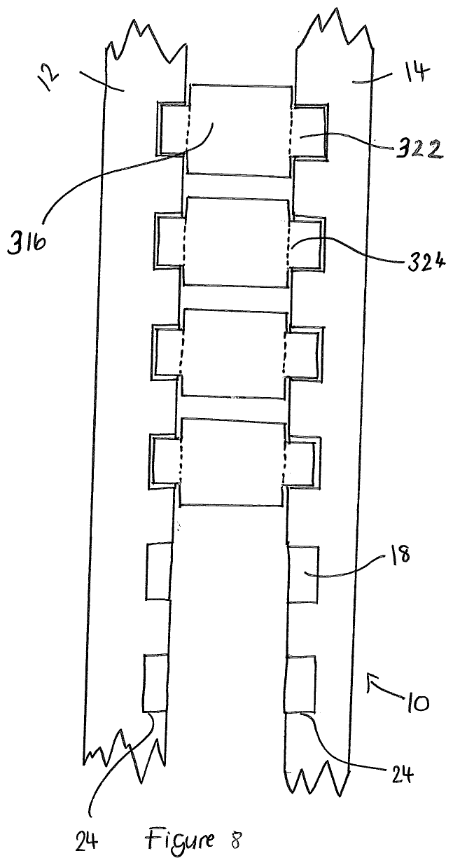

FIG. 6 illustrates a side cross-sectional view of a label strip according to an embodiment of the present invention wherein two strips of adhesive material 18, 20 are provided which each only extends across of portion of the width of each of the bands 12, 14.

1. A label strip, comprising:
a first band and a second band, wherein the first band has a width and a thickness and the second band has a width and a thickness, and wherein the thicknesses of the first and second bands are substantially the same;
a label, wherein the label has a width, a length and a thickness;
wherein each of the first and second bands is provided with a cut out at least substantially the same width as the width of the label and having a depth of less than the width of each of the first and second bands;
wherein the first and second bands are located parallel to each other with a gap therebetween;
wherein the gap between the bands, plus the depths of each of the cut outs, is at least substantially the same as the length of the label such that, when the label is located between the first and second bands, the label fits into the gap created between the cut outs of the bands; and
wherein a layer of adhesive material is provided on one side of the first and second bands extending over the cut outs such that the label, when positioned in the cut outs, is held in position by the adhesive material.

2. A label strip as claimed in claim 1, wherein
the label is provided with a protrusion at one end of the length thereof,
wherein one of the cut outs is at least substantially the same width as the width of the protrusion and one of the cut outs is at least substantially the same width as the label, and
wherein the gap between the bands, plus the depths of each of the cut outs, is at least substantially the same as the length of the label plus protrusion.

3. A label strip as claimed in claim 1, wherein
the label is provided with a protrusion at each end of the length thereof,
wherein each of the cut outs are at least substantially the same width as the width of the protrusion, and
wherein the gap between the bands, plus the depths of each of the cut outs, is at least substantially the same as the length of the label plus protrusions.

4. A label strip as claimed in claim 1, wherein the label is substantially the same thickness as the thickness of the first and second bands.

5. A label strip as claimed in claim 1, wherein the thickness of the label is greater than the thickness of the first and second bands.

6. A label strip as claimed in claim 1, comprising a second layer of adhesive material is provided on the other side of the first and second bands extending over the cut outs such that the label, when positioned in the cut outs, is held in position by the adhesive material both on the top and on the bottom.

7. A label strip as claimed in claim 1, wherein the first and second bands are provided with apertures for use with a continuous feed style printer.

8. A label strip as claimed in claim 2, wherein when the label is provided with a protrusion, the protrusion is substantially the same shape as the cut out.

9. A label strip as claimed in claim 2, wherein the label is provided with a plurality of protrusions and each of the first and second bands is provided with a plurality cut outs of the same shape as the protrusions.

10. A label strip as claimed in claim 2, wherein the label is provided with a plurality of protrusions, and wherein the protrusions on either side of the label are not the same as each other.

11. A label strip as claimed in claim 10, wherein a different number of protrusions are provided on either side of the label.

12. A label strip as claimed in claim 11, wherein one protrusion is provided on one side of the label with a matching cut out in the first band and two protrusions are provided on the other side of the label with matching cut outs in the second band.

13. A label strip as claimed in claim 10, wherein the protrusions are of different shapes to each other.

14. A label strip as claimed in claim 13, wherein the protrusion on one side of the label comprises a circular tab with a matching cut out in the first band and the protrusion on the other side of the label comprises a square tab with a matching cut out in the second band.

15. A label strip as claimed in claim 1, wherein each end of the label is provided with a perforation configured to allow the label to be detached from the label strip.

16. A label strip as claimed in claim 1, wherein the label is configured to be printed on.

17. A label strip as claimed in claim 1, wherein the widths of the first and second bands are substantially the same.

18. A label strip as claimed in claim 1, wherein the widths of the first and second bands are different such that one is wider than the other.

19. A label strip as claimed in claim 1, wherein the first and/or second bands are configured to be printed on.

20. A label strip as claimed in claim 1, wherein the label is a heat shrink label.
